(19) United States
(12) Patent Application Publication
(10) Pub. No.: US 2017/0334587 A1
(43) Pub. Date: Nov. 23, 2017

(54) Cable Tie Tensioning And Cut Off Tool

(71) Applicant: Delphi Technologies, Inc., Troy, MI (US)

(72) Inventors: Robert Alan McFall, West Farmington, OH (US); John C. McLane, Warren, OH (US); Jeffrey Michael Hickox, Middlefield, OH (US); Robert L. Dean, New Castle, PA (US); John Thomas Kightlinger, Canfield, OH (US)

(21) Appl. No.: 15/159,395

(22) Filed: May 19, 2016

(51) Int. Cl. B65B 13/02; B26D 7/14; B25B 25/00

(52) U.S. Cl. CPC B65B 13/027; B25B 25/00; B26D 7/14

(57) ABSTRACT

A tool configured to tension an elongate cable tie around a wire cable bundle and sever a portion of a tie tail from the cable tie. This tool includes a pistol-shaped housing having a handle portion and a barrel portion. A slide mechanism disposed within the barrel portion comprises a gripper mechanism configured to grip a tail of the cable tie and a slide configured to move the gripper mechanism in a direction toward an end of the barrel portion and pull the tail of the cable tie through the tie head, thereby tightening the cable tie around the wire cable bundle. The tool also includes a tensioning mechanism that is configured to halt application of the tension to the cable tie when the tension applied by the slide mechanism reaches a predetermined tension threshold and a cutoff mechanism configured to sever the tie tail from the cable tie.

### TECHNICAL FIELD OF THE INVENTION

The invention relates to a hand held tensioning and cutting tool for cable ties, in particular to a tool that tensions the cable tie by pulling the cable tie away from the tool operator.

### BACKGROUND OF THE INVENTION

Cable ties are widely used in a variety of environments and applications. They may be used, for example, to bundle a plurality of elongate wires, cables, such as those used in automotive wiring harnesses or other elongate articles. Cable ties may also be used to secure elongate articles to rigid structures or used as hose clamps. Such cable ties typically include an elongate tie tail which is threaded through an integral tie head to encircle the articles to be bound and the cable tie tail is drawn through the cable tie head to tightly bind the elongate articles into a bundle.

Current cable tie tools require an operator to pull the cable tie tail towards the operator when the tool is activated. This tail is progressively pulled back by repeatedly pulling a trigger on the tool until the wire tie is tightened to a pre-set tension setting around the wire cable bundle. The tool then automatically cuts the excess portion of the cable tie tail off, and the operation is complete. Examples of these types of cable tie tools may be found, inter alia, in U.S. Pat. Nos. 7,124,787, 8,955,556, and 8,960,241.

There are specific cable tie applications where the cable ties applied to wire harnesses attached to assembly boards are oriented in an opposite direction, i.e., the tie tail of the cable tie faces the assembly board (opposing direction from the operator). Currently available cable tie tools are only capable of pulling the tie tails in the direction toward the operator. The current cable tie tools may be used in these applications, but the operator is required to re-orient the wire harness bundle by twisting the wire harness bundle to apply each cable tie so oriented. This makes the current cable tie tools very awkward for the operator to use in these applications to achieve the desired result and may not conform to ergonomic guidelines. Therefore, a cable tie tool capable of applying a cable tie wherein the tie tail is oriented in a direction opposite the operator without reorienting the wiring harness remains desired.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

### BRIEF SUMMARY OF THE INVENTION

In accordance with a first embodiment of the invention, a tool configured to tighten an elongate cable tie around a wire cable bundle is provided. The tool includes a pistol-shaped housing having a handle portion and a barrel portion. A slide mechanism is disposed within the barrel portion. The slide mechanism is configured to engage a tie head of the cable tie and pull a tie tail of the cable tie through the tie head in response to movement of a trigger in a direction toward the handle portion, thereby tightening the cable tie around the wire cable bundle. The tie tail is pulled in a direction toward an end of the barrel portion opposite the handle portion.

The barrel portion may define a lateral slot extending through the barrel portion that is configured to accommodate the wire cable bundle. The barrel portion may also define a longitudinal slot between this lateral slot and an end of the barrel portion. The longitudinal slot is configured to accommodate a portion of the tie tail extending through the tie head.

The tool may further include a tensioning mechanism that is configured to stop application of tension to the cable tie by the slide mechanism when the tension applied by the slide mechanism reaches a predetermined tension threshold and a cutoff mechanism also disposed within the barrel portion that is configured to sever the portion of the tie tail extending through the tie head from the cable tie when the tensioning mechanism stops the slide mechanism from applying the tension to the cable tie.

The trigger may be an elongate member that extends downwardly from the barrel portion and is located forward of the handle portion. The trigger may be displaceable toward and toward an end of the barrel portion opposite the handle portion and is coupled to the slide mechanism. Alternatively, the trigger may a button configured to control a powered actuator that is coupled to the slide mechanism. The powered actuator may be a pneumatically powered actuator.

In accordance with another embodiment of the invention, a tool configured to tension an elongate cable tie around a wire cable bundle and sever a portion of a tie tail from the cable tie is provided. This tool includes a pistol-shaped housing having a handle portion and a barrel portion, and a slide mechanism disposed within the barrel portion. The slide mechanism comprises a serrated gripper that is configured to grip the tie tail of the cable tie and a slide that is configured to move the gripper in a direction toward an end of the barrel portion opposite the handle portion and pull the tie tail of the cable tie through the tie head, thereby tightening the cable tie around the wire cable bundle. The tool also includes a tensioning mechanism that is configured to halt application of the tension to the cable tie by the slide mechanism when the tension applied by the slide mechanism reaches a predetermined tension threshold. The tool further includes a cutoff mechanism located within the barrel portion that is configured to sever the portion of the tie tail extending through the tie head from the cable tie. The cutoff mechanism has a cam that causes the cutoff mechanism to rotate about a pivot pin when the tensioning mechanism stops the slide mechanism from applying the tension to the cable tie.

The barrel portion may define a lateral slot extending through the barrel portion which is configured to accommodate the wire cable bundle. The barrel portion may further define a longitudinal slot between the lateral slot and an end of the barrel portion that is configured to accommodate the portion of the tie tail extending through the tie head.

The tool may additionally include an elongate trigger that is coupled to the slide mechanism. This trigger extends downwardly from the barrel portion and forward of the handle portion. A movement of the trigger about a trigger pivot pin in a direction toward the handle portion moves the slide mechanism in the direction toward an end of the barrel portion opposite the handle portion. The tool may instead include a trigger button that is disposed on the handle portion and connected to a powered actuator coupled to the slide mechanism. The powered actuator is configured to move the slide mechanism in the direction toward an end of the barrel portion opposite the handle portion when the trigger button is activated. The powered actuator may be a pneumatically powered actuator.

### BRIEF DESCRIPTION OF THE SEVERAL VIEWS OF THE DRAWING

The present invention will now be described, by way of example with reference to the accompanying drawings, in which:

FIG. 1 is a side view of a manually operated cable tie tensioning and cut off tool according to one embodiment;

FIG. 2 is a perspective side view of the tool of FIG. 1 with a wire bundle disposed in the lateral slot through the barrel portion of the housing according to one embodiment;

FIG. 3 is a cutaway side view of the tool of FIG. 1 with the trigger in the initial position according to one embodiment;

FIG. 4 is a perspective view of the trigger of the tool of FIG. 1 according to one embodiment;

FIG. 5 is a side view of the tie-gripping pawl of the tool of FIG. 1 while the trigger is in the initial position of FIG. 3 according to one embodiment;

FIG. 6 is a side view of the tool of FIG. 1 with the trigger in a first intermediate position according to one embodiment;

FIG. 7 is a side view of the tool of FIG. 1 with the trigger in a second intermediate position according to one embodiment;

FIG. 8 is a side view of the tool of FIG. 1 with the trigger in a final position according to one embodiment; and

FIG. 9 is a cut away side view automatically operated cable tie tensioning and cut off tool according to another embodiment.

### DETAILED DESCRIPTION OF THE INVENTION

Although the disclosure hereof is detailed and exact to enable those skilled in the art to practice the invention, the physical embodiments herein disclosed merely exemplify the invention which may be embodied in other specific structures. While a preferred embodiment has been described, the details may be changed without departing from the invention.

A description of example embodiments of the invention follows.

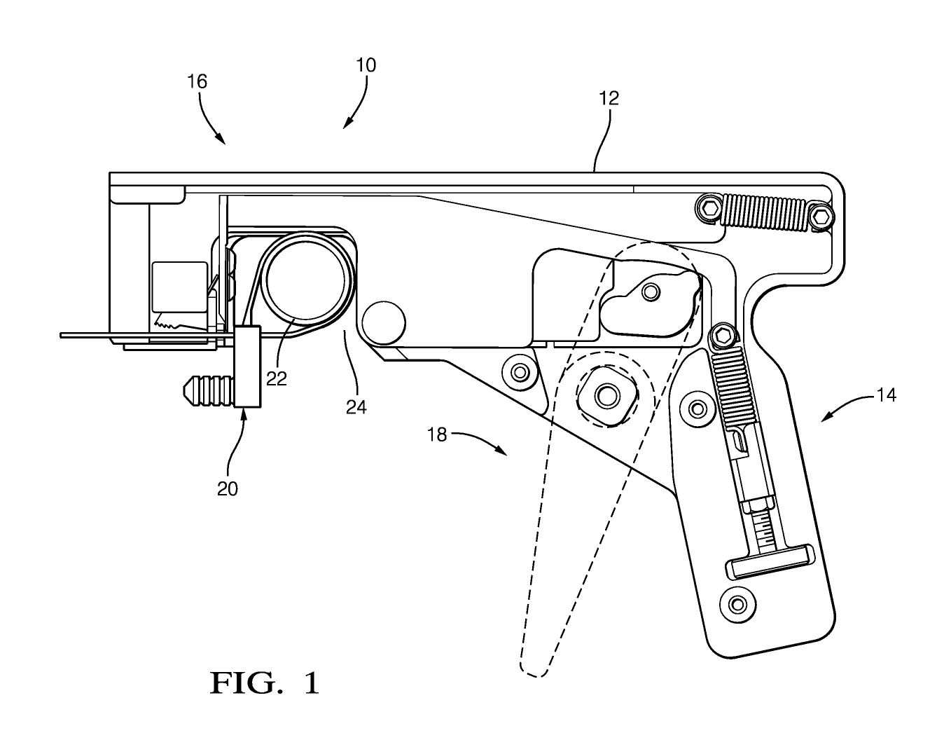

Referring now to the drawings and in particular to FIGS. 1-8, a non-limiting example of a manually operated tool 10 incorporating the principles of the present invention is shown as having a housing 12 in the shape of a pistol or gun. As illustrated in FIG. 1, the tool 10 has a grip or handle portion 14, a barrel portion 16 projecting from the handle portion 14, and a trigger 18. The trigger 18 is located forward of the handle portion 14 and under the barrel portion 16 where it fits naturally in the hand of a user (not shown).

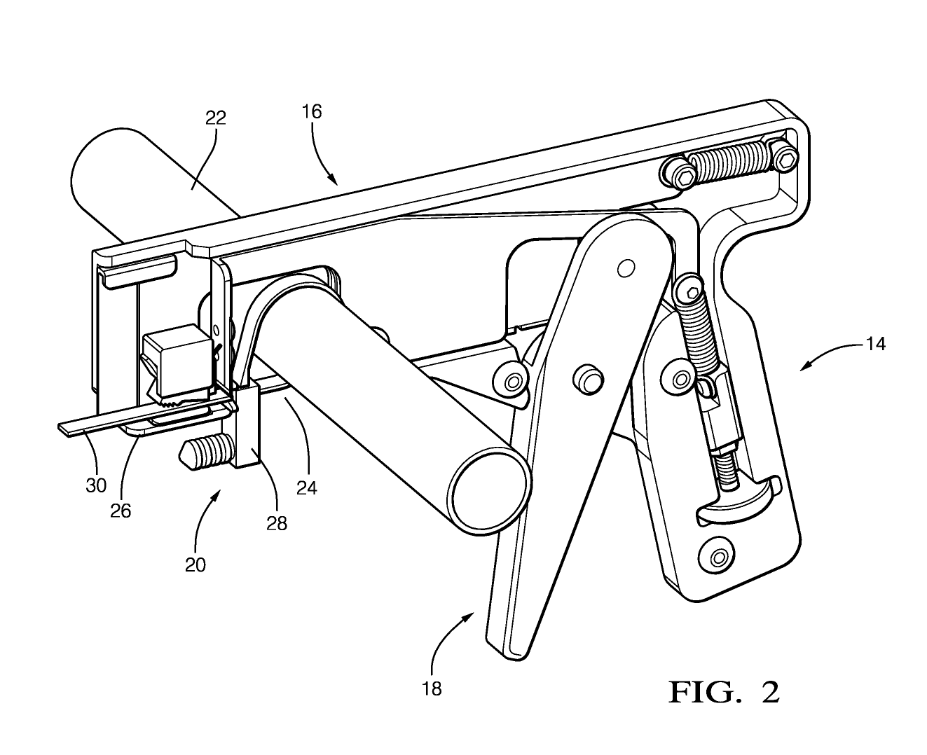

The tool 10 is typically used to install cable ties 20 around elongate bundles 22, such as wire cable or the like. As mentioned in the BACKGROUND OF THE INVENTION, cable ties 20 are widely used in a variety of environments and applications, and may be used, for example, to bundle a plurality of elongate wires, cables, or other elongate articles, as shown in the Figures. As shown in FIG. 2, a lateral slot 24 in the bottom edge 26 of the barrel portion 16 is configured to accommodate the elongate bundle 22 as the cable tie 20 is tightened around the bundle 22.

However, it is to be understood that the tool 10 of the present invention may be used to secure cable ties 20 in other applications, such as to secure elongate articles to rigid structures or used as hose clamps (not shown), by way of non-limiting example.

As illustrated in FIG. 2, a cable tie 20 includes a tie head 28 and a tie tail 30. The tool 10 grips the tie tail 30 of the cable tie 20 and pulls it through the tie head 28 in a direction F away from the handle portion 14 until a predetermined tension threshold is achieved. The tool 10 then automatically cuts off an excess portion of the tie tail 30 adjacent the tie head 28. This allows cable ties 20 to be applied to a wire cable bundle 22 (e.g. wire harness assembly) attached to an assembly board when the cable tie 20 is oriented in direction wherein the tie tail 30 of the cable tie 20 faces the assembly board, i.e., away from the operator, without having to twist the wire cable bundle 22 to grip the tie tail 30 with the tool 10.

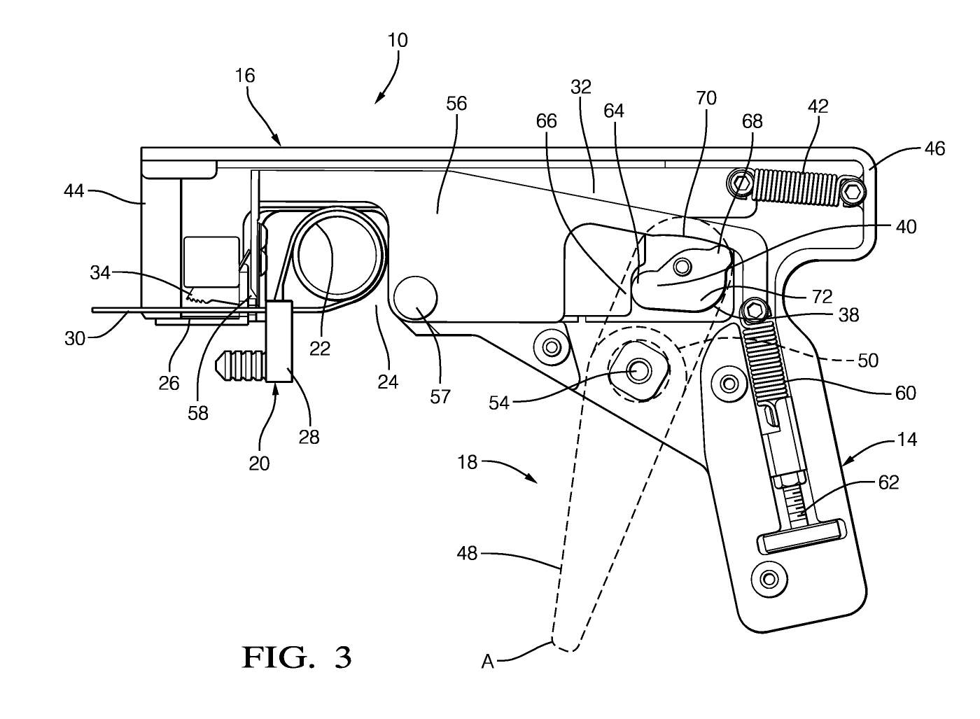

As seen in FIGS. 3-8, one housing sidewall has been cut away to show the opposite housing sidewall and the internal parts and mechanism of the present tool 10. The tool 10 generally contains a reciprocating slide mechanism in the form of a slide plate 32 (see FIG. 5) located in the barrel portion 16 of the tool 10. The slide plate 32 further includes a gripping mechanism 34, such as the tie-gripping pawl 34 shown, for gripping the tie tail 30 of the cable tie 20. The slide plate 32 is pushed in a forward direction F in the barrel portion 16 by a cam 38 that is mounted to the trigger 18 by a cam pivot pin 40. The slide plate 32 is pulled in a rearward direction R by a return spring 42 attached to the barrel portion 16. As used herein, the direction toward an end of the barrel portion 44 opposite the handle portion 14 is referred to forward and a direction toward an end of the barrel portion 46 adjacent the handle portion 14 is referred to as backward.

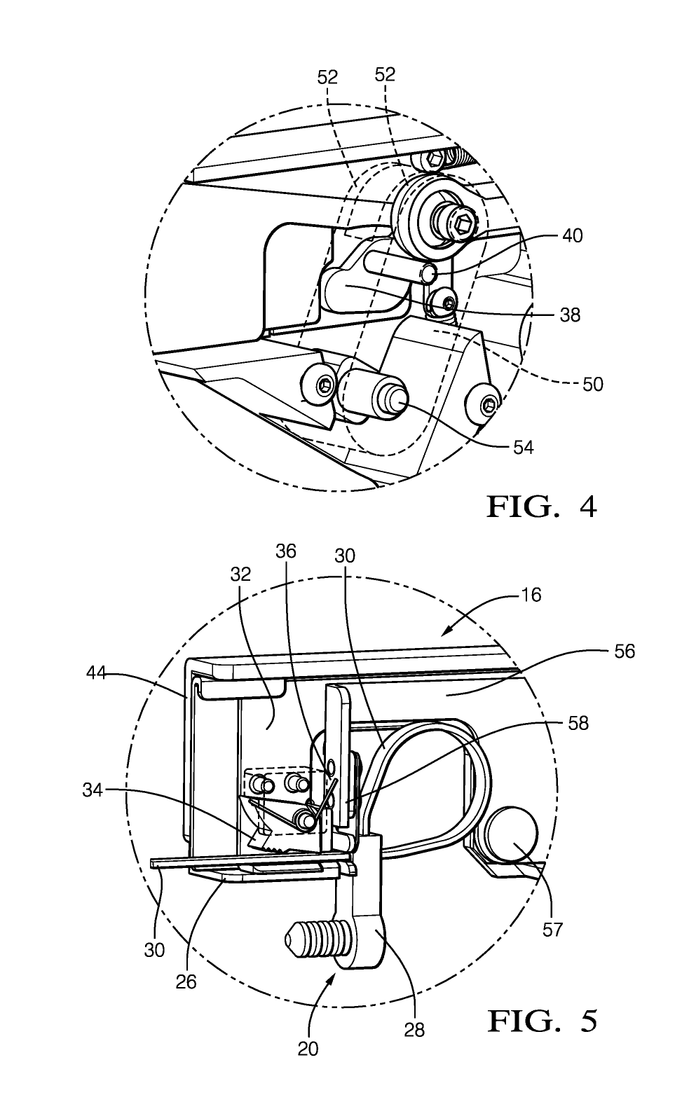

As shown in FIG. 4, the trigger 18 has a trigger handle portion 48 which protrudes beneath the barrel portion 16 and forward to the handle portion 14. The trigger 18 also has a clevis or forked portion 50 having two generally parallel arms 52. The cam 38 and cam pivot pin 40 are disposed between these two arms 52. The trigger 18 is attached to the housing 12 by the trigger pivot pin 54 in a location intermediate the trigger handle portion 48 and the trigger forked portion 50.

The cam 38 is also in contact with a cutoff mechanism 56 which is an arm attached to the barrel portion 16 by a cutoff pivot pin 57. The cutoff mechanism 56 has a blade member 58 on the forward end and is attached to a tension spring 60 in the form of a coil spring 60 on the rearward end of the cutoff mechanism 56.

In operation, the slide plate 32 pulls the gripped tie tail 30 forwardly to a predetermined tension. Upon reaching the predetermined tension, the cam 38 then activates the cutoff mechanism 56 to cause the blade member 58 to cut off the tie tail 30 closely adjacent the tie head 28. The predetermined tension is set or adjusted by way of a tension adjustment mechanism 62 located in the handle portion 14 of the tool 10. The structure and operation of the tool 10 will now be described in greater detail.

As shown in FIG. 3, in the initial trigger position a, a forward surface 64 of the cam 38 is near contact or in contact with a slide cam surface 66 of the slide plate 32 and a rearward surface 68 of the cam 38 is in contact with a cutoff cam surface 70 of the cutoff mechanism 56. The cutoff cam surface 70 is held in contact with the rearward surface 68 by the tension spring 60. The amount of force applied to the cutoff mechanism 56 by the tension spring 60 may be adjusted by turning an adjusting screw 62 that is attached between an end of the spring and the handle portion 14 of the tool 10.

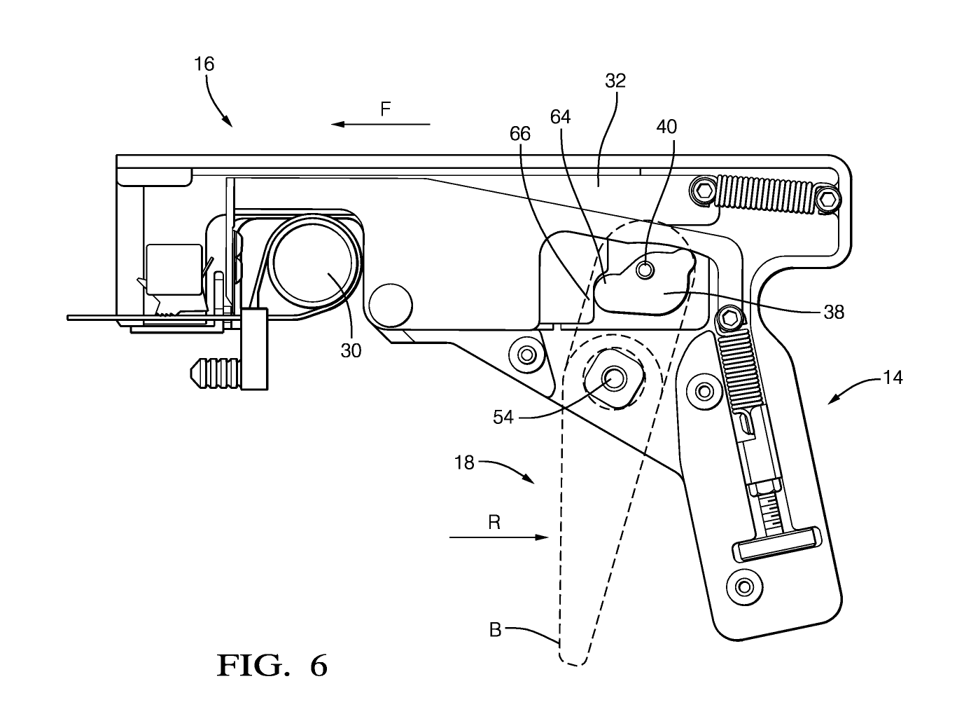

As shown in FIG. 5, while the trigger 18 is still in the initial position A, the tie-gripping pawl 34, which is mounted to the slide plate 32 by a pawl pivot pin, engages a pawl stop 36 mounted on the barrel portion 16 and located on the forward edge of the lateral slot 24. The engagement with the pawl stop causes the tie-gripping pawl 34 to rotate away from the lower edge of the barrel portion 16, thereby allowing insertion of the tie tail 30 into a longitudinal slot running from the lateral slot 24 to the forward end of the barrel portion 16. As shown in FIG. 5, the tie-gripping pawl 34 includes a torsion spring that is wrapped about the pawl pivot pin and rotates the tie-gripping pawl 34 toward the lower edge of the barrel portion 16 into contract with the tie tail 30 as the slide plate 32 moves the tie-gripping pawl 34 in the forward direction F in FIG. 6 and out of engagement with the pawl stop 36. The tie-gripping pawl 34 has lateral serrations to provide positive grip of the tie tail 30.

As illustrated in FIG. 6, when the trigger 18 is in a first intermediate position B as it is squeezed toward the handle in the direction of arrow R. The trigger 18 moves about the trigger pivot pin 54 and the cam pivot pin 40 is moved in the forward direction F, pushing the forward surface 64 of the cam 38 against the slide cam surface 66 of the slide plate 32 and moves the slide plate 32 in the forward direction F within the barrel portion 16 and away from the handle portion 14.

As the trigger 18 is further squeezed toward the handle portion 14 in the direction of arrow R in FIG. 6, the forward surface 64 of the cam 38 continues to push against the slide cam surface 66 of the slide plate 32 and moves the slide plate 32 in the forward direction F within the barrel portion 16 while the tie-gripping pawl 34 pulls the tie tail 30 away from the handle portion 14 as the cable tie 20 is tightened about the wire cable bundle 22. As the cam 38 moves in the forward direction F, the tension spring 60 keeps the cutoff cam surface 70 of the cutoff mechanism 56 in contact with the rearward surface 68 of the cam 38.

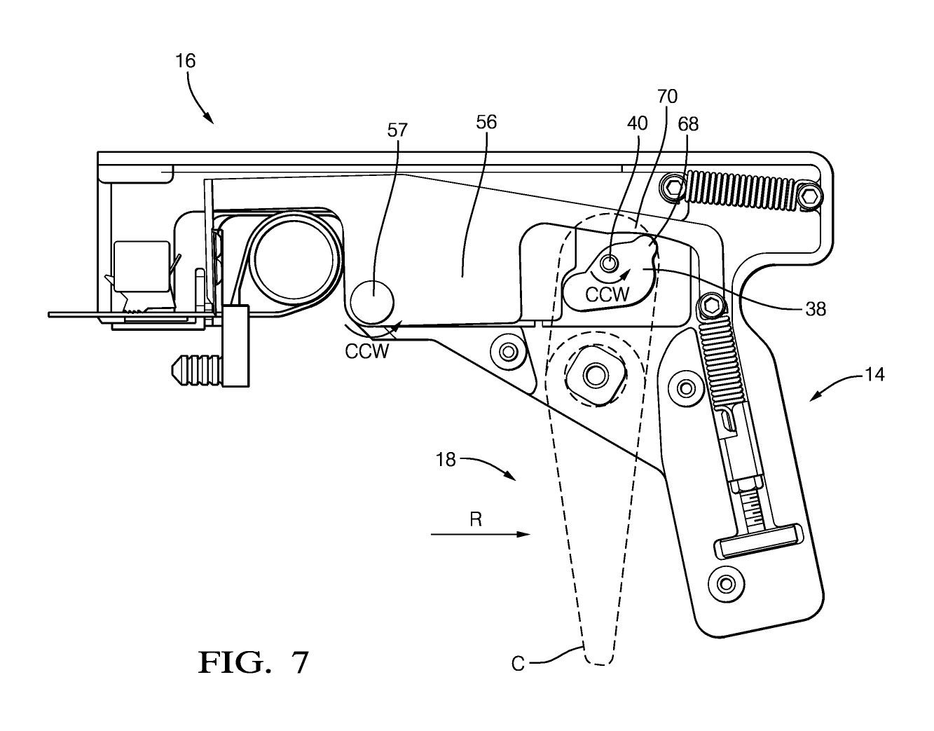

As illustrated in FIG. 7, when the trigger 18 moves to a second intermediate position C as it is squeezed toward the handle in the direction of arrow R, the tension in the cable tie 20 reaches a predetermined tension threshold. Further movement of the trigger 18 toward the handle portion 14 will no longer cause the cam 38 to push the slide plate 32 in the forward direction F. Rather, further movement of the trigger 18 causes the cam 38 to rotate around the cam pivot pin 40 in a counterclockwise direction as indicated by arrow CCW.

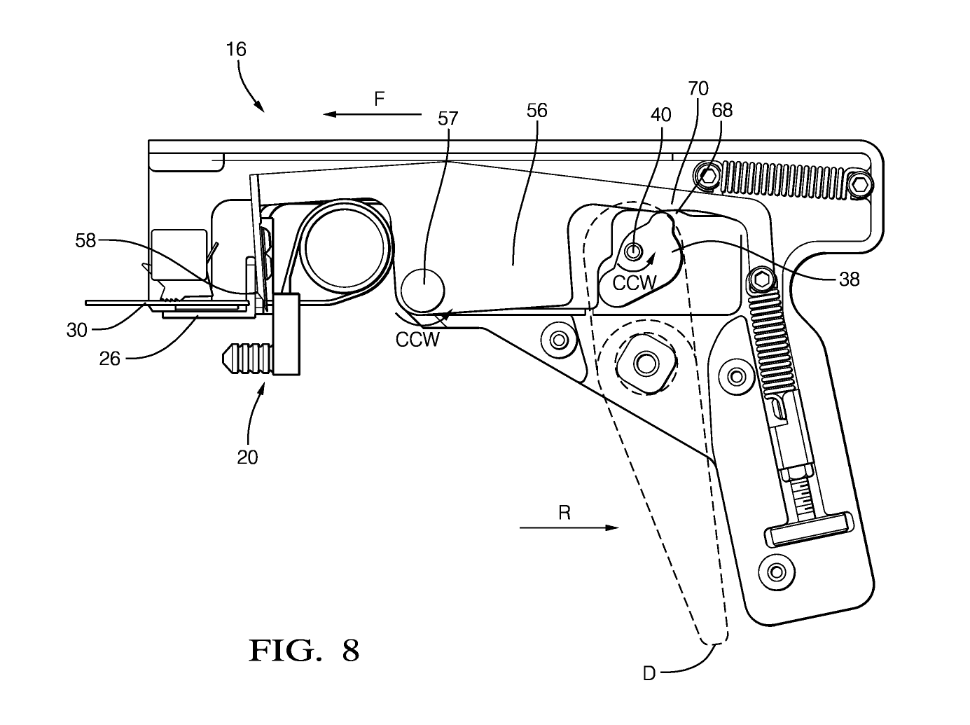

As illustrated in FIG. 8, when the cam 38 rotates in the counterclockwise direction CCW, the rearward surface 68 of the cam 38 slides along the cutoff cam surface 70 of the cutoff mechanism 56 and rearward surface 68 engages the cutoff cam surface 70 of the cutoff mechanism 56. As the cam 38 rotates, the rearward surface 68 lifts the rearward end of the cutoff mechanism 56 causing it to rotate in the counterclockwise direction about the cutoff pivot pin 57, thereby bringing the blade member 58 on the forward end of the cutoff mechanism 56 into contact with the lower surface 26 of the barrel portion 16 and thus severing the portion of the tie tail 30 from the cable tie 20. The trigger 18 reaches a final position D when the tie tail 30 is severed.

The preset threshold is set by the adjustment screw 62 that increases or decreased the tension in the tension spring 60. As the tension in the tension spring 60 is decreased the tension threshold is reduced and as the tension in the tension spring 60 is increased the tension threshold is raised.

As the trigger 18 is released, the return spring 42 pulls the slide plate 32 in the rearward direction R and the trigger 18 away from the handle portion 14 to the initial position A shown in FIG. 3. Also as the trigger 18 is released, the tension spring 60 causes the cam 38 to rotate back to its initial position A shown in FIG. 3, in which the forward surface 64 is in contact with the slide cam surface 66 and the rearward surface 68 is in contact with the cutoff cam surface 70.

As shown in FIG. 8, the tool 10 also incorporates a wear plate 44 formed of a sheet metal material that is disposed intermediate the slide plate 32 and the barrel portion 16 of the housing 12. The wear plate 44 is configured to reduce wear of the housing 12 as the slide plate 32 moves within the housing 12.

While the tool 10 illustrated in FIGS. 1-8 has a trigger 18 located forward of the handle portion 14, other embodiments of the tool may be envisioned that include a trigger located rearward of the handle portion 14. These embodiments would also include mechanical linkages to convert the movement of the trigger toward the handle to forward movement of the cam 38.

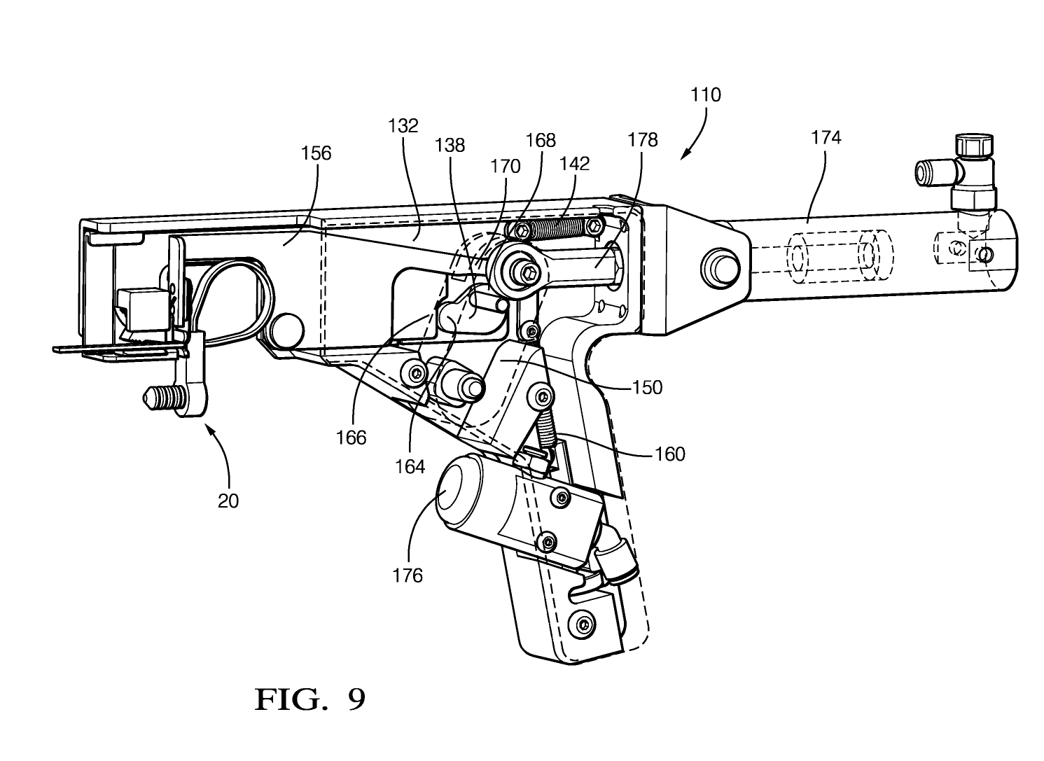

A non-limiting example of an automated tool 110 incorporating the principles of the present invention is illustrated in FIG. 9. As can be seen in FIG. 9, the configuration of the automated tool 110 is very similar to that of the manually operated tool 10 described previously. The reference numbers of elements similar to those of the manually operated tool 10 differ by 100. The primary difference between the manually operated tool 10 and the automated tool 110 is the elimination of the handle portion 14 of the trigger 18 and the addition of a pneumatically powered cylinder 174 attached to the trigger forked portion 150. A trigger button 176 controlling a valve between the air supply (not shown) and the pneumatic cylinder 174 is also incorporated in the automated tool 110.

In operation, the trigger button 176 is pressed to open the air valve to the pneumatic cylinder 174, pressurizing a cylinder (not shown) within the pneumatic cylinder 174 and forcing an actuator rod 178 of the pneumatic cylinder 174 attached to the forked trigger portion 150 forward. The cam pivot 140 pushes cam 138 forward which in turn pushes the slide plate 132 forward and the tool 110 operates as does the manual tool 10 as the actuator rod 178 pushes the slide plate 132 forward. After the cable tie 20 is tensioned by the slide plate 132 and the tie tail 30 severed by the cutoff mechanism 156, the trigger button 176 is released closing the air valve and depressurizing the cylinder. The return spring 142 then pulls the slide plate 132 in the rearward direction R and tension spring 160 causes the cam 138 to rotate back to its initial position A, in which the forward surface 164 is in contact with the slide cam surface 166 and the rearward surface 168 is in contact with the cutoff cam surface 170. The actuator rod 178 may also be returned to its initial position A by the return spring 142 or the pneumatic cylinder 174 may include a second return spring (not shown) configured to return the actuator rod 178 back to its original position when the cylinder is unpressurized.

Alternative embodiments of the automated tool 110 may employ a linear hydraulic actuator wherein the trigger button 176 activates a hydraulic valve or a linear electrical actuator wherein the trigger button 176 activates an electrical switch.

Thus, a tool 10 configured to tighten an elongate cable tie 20 around a wire cable bundle 22. This tool 10 pulls a tie tail 30 of a cable tie 20 away from the handle portion 14 of the tool 10 which provides the benefits of allowing an assembly operator to tension a cable tie 20 around a wire cable bundle 22, such as an automotive wiring harness, when the tie tail 30 is projecting from the tie head 28 in a direction away from the operator without the need to the operator to twist the wiring harness in order to grip the tie tail 30 with the cable tie tensioning tool 10. The tool 10 has a lateral slot 24 cut out of the barrel portion 16 to accommodate the wiring harness as the cable tie 20 is tensioned around the wiring harness. The barrel portion 16 also had a longitudinal slot running from the lateral slot 24 to the end of the barrel portion 16 to allow the tie tail 30 to be easily engaged with the tie-gripping pawl 34. The tool may be manually or automatically actuated.

While this invention has been described in terms of the preferred embodiments thereof, it is not intended to be so limited, but rather only to the extent set forth in the claims that follow. Moreover, the use of the terms first, second, etc. does not denote any order of importance, but rather the terms first, second, etc. are used to distinguish one element from another. Furthermore, the use of the terms a, an, etc. do not denote a limitation of quantity, but rather denote the presence of at least one of the referenced items. Additionally, the use of the locational terms such as upper, lower, forward, and rearward do not denote an absolute location or orientation by rather a relative location or orientation of one element to another.

We claim:

1. A tool configured to tighten an elongate cable tie around a wire cable bundle, comprising:
a pistol-shaped housing including a handle portion and a barrel portion;
a slide mechanism within the barrel portion configured to engage a tie head of the cable tie and pull a tie tail of the cable tie through the tie head in response to movement of a trigger in a direction toward the handle portion, thereby tightening the cable tie around the wire cable bundle, wherein the tie tail is pulled in a direction toward an end of the barrel portion opposite from the handle portion.

2. The tool according to claim 1, wherein the barrel portion defines a lateral slot extending therethrough configured to accommodate the wire cable bundle.

3. The tool according to claim 2, wherein the barrel portion defines a longitudinal slot between the lateral slot and an end of the barrel portion configured to accommodate a portion of the tie tail extending through the tie head.

4. The tool according to claim 3, further comprising:
a tensioning mechanism in the barrel portion configured to stop application of tension to the cable tie by the slide mechanism when the tension applied by the slide mechanism reaches a predetermined tension threshold; and
a cutoff mechanism in the barrel portion configured to sever the portion of the tie tail extending through the tie head from the cable tie when the tensioning mechanism stops the slide mechanism from applying the tension to the cable tie.

5. The tool according to claim 4, wherein the trigger is an elongate member extending downwardly from the barrel portion, forward of the handle portion, displaceable toward and toward an end of the barrel portion opposite the handle portion, and coupled to the slide mechanism.

6. The tool according to claim 4, further comprising:
a powered actuator coupled to the slide mechanism, wherein the trigger controls the powered actuator.

7. The tool according to claim 6, wherein the powered actuator is a pneumatically powered actuator.

8. A tool configured to tension an elongate cable tie around a wire cable bundle and sever a portion of a tie tail from the cable tie, comprising:
a pistol-shaped housing including a handle portion and a barrel portion;
a slide mechanism comprising a gripper mechanism configured to grip the tie tail of the cable tie and a slide configured to move the gripper mechanism in a direction toward an end of the barrel portion opposite the handle portion and apply tension to the cable tie by pulling the tie tail of the cable tie through the tie head, thereby tightening the cable tie around the wire cable bundle;
a tensioning mechanism configured to halt application of the tension to the cable tie by the slide mechanism when the tension applied by the slide mechanism reaches a predetermined tension threshold; and
a cutoff mechanism in the barrel portion configured to sever the portion of the tie tail extending through the tie head from the cable tie, said cutoff mechanism having a cam that causes the cutoff mechanism to rotate about a pivot pin when the tensioning mechanism stops the slide mechanism from applying the tension to the cable tie.

9. The tool according to claim 8, wherein the barrel portion defines a lateral slot extending therethrough configured to accommodate the wire cable bundle.

10. The tool according to claim 9, wherein the barrel portion defines a longitudinal slot between the lateral slot and an end of the barrel portion configured to accommodate the portion of the tie tail extending through the tie head.

11. The tool according to claim 8, further comprising an elongate trigger coupled to the slide mechanism, said trigger extending downwardly from the barrel portion and forward of the handle portion, wherein movement of the trigger about a trigger pivot pin in a direction toward the handle portion moves the slide mechanism in the direction toward an end of the barrel portion opposite the handle portion.

12. The tool according to claim 8, further comprising:
A trigger button disposed on the handle portion and connected to a powered actuator coupled to the slide mechanism, wherein the powered actuator is configured to move the slide mechanism in the direction toward an end of the barrel portion opposite the handle portion when the trigger button is activated.

13. The tool according to claim 12, wherein the powered actuator is a pneumatically powered actuator.
